(19) United States
(12) Patent Application Publication
(10) Pub. No.: US 2017/0103665 A1
(43) Pub. Date: Apr. 13, 2017

(54) Educational Institution Tutoring Method

(71) Applicants: Alex Shchegol, Staten Island, NY (US); Margarita Furer, Staten Island, NY (US)

(72) Inventors: Alex Shchegol, Staten Island, NY (US); Margarita Furer, Staten Island, NY (US)

(73) Assignee: ASA College, Inc., Brooklyn, NY (US)

(21) Appl. No.: 15/270,644

(22) Filed: Sep. 20, 2016

Related U.S. Application Data
(60) Provisional application No. 62/240,995, filed on Oct. 13, 2015.

(51) Int. Cl. G09B 5/14; G09B 5/12

(52) U.S. Cl. CPC G09B 5/14; G09B 5/12

(57) ABSTRACT

A tutoring management system for an educational institution, e.g., a high school, college or university, etc., requires all instructors and students defined as being “at risk” of dropping out of school to participate in the tutoring program. The students are evaluated based on five classroom criteria comprising classroom participation, required reading, homework/assignments, questions answered, and quizzes. All students are given a grade based on an instructor's evaluation of the student on a preferred weekly basis. All data is entered into a database that issues reports and automated emails on a private school intraweb system database server via local institution or personal computers or via the internet. Students whose weekly grade is below B or its numerical equivalent or have poor class room attendance is deemed “at risk” and must attend assigned tutoring. The instructors must evaluate each of their students with preferred weekly grades in each criteria and must provide the tutoring to their students, or request other instructors to perform tutoring or assign the students to a Learning Center for tutoring. The Administration and others of the school hierarchy including instructors and students get various reports and automated emails. Non-compliant instructors who fail to evaluate the students or assign tutoring are reported to the administration. A Learning Center includes tutors who comprise students, instructors and professionals for those instructors not able to participate with tutoring and for walk in students.

This application claims the benefit of U.S. Provisional application No. 62/240,885 filed Oct. 13, 2015 in the name of the present inventors incorporated by reference in its entirety. This invention relates to a tutoring methodology for reducing the dropout rate of underperforming students in an educational institution.

Tutoring systems in educational institutions such as schools at all levels including colleges and universities are known. For example, Michigan State University has a Tutorial Management System that is available on the internet. This system tracks students and tutors working hours, but does not keep track of a student's academic performance.

US Publication No. 2008/0221963 discloses a system and method of academic tutoring. Disclosed is a system and method for the management of an academic tutoring service that provides a series of interfaces, each providing functionality useful to a different user category, for use in the organization and management of the academic tutoring process. Included is the ability to create schedules for students and tutors, automatic invoicing to parents and tutoring session report generation.

US Publication No. 2007/0099167 discloses a method and computer program for monitoring, tracking and enhancing a student performance. The disclosed method includes receiving student information including course information for one or more enrolled courses for a student in an educational institution, receiving course requirement information for each of the enrolled courses, receiving student monitoring criteria of the educational institution including one or mare grading thresh holds associated with the enrolled courses, periodically receiving student performance information for the student including test results for the enrolled courses, periodically monitoring the student performance information including automatically determining whether the testing results are below the grading threshold associated with the enrolled course, and notifying the educational institution if the test results are below the grading threshold associated with the enrolled course.

US Publication No. 20080261193 discloses a management information system including computer implemented method and computer product for managing tutoring services. A network server is provided and includes a data base that comprises tutor records, each tutor record being associated with an individual tutor and including tutoring data representing an available tutoring subject and a tutoring locality. A second database component is operative to maintain a plurality of student records, each student record being associated with an individual student and including student data representing a requested tutoring subject and a student locality. A database engine is operatively loaded in the memory and includes instructions to determine a suggested tutor/student allocation in dependence on a correspondence of at least the data representing a tutoring subject and locality among the tutor and student records, generate a suggested tutor/student allocation and output the suggested tutor/student allocation in a tiered order or preference of tutors and sends notices to identified tutors.

US Publication No. 2011/0010306 discloses an educational information management system and education recommendation generation. This document does not relate to tutoring of students or improving their performance in an educational institution.

U.S. Pat. No. 7,882,041 to Gibbons et al. discloses s system and method for optimizing the effectiveness of an educational institution. Disclosed is the monitoring of a students progress which is measured and the student's need for support and attention is determined. This document does not relate to providing tutoring services or the monitoring the academic improvement of a student by such services.

The present inventors recognize that the above references do not disclose satisfactory systems that will actually improve a student's academic performance continually during the school education term. For example, Gibbons only evaluates the effectiveness of an educational institution, but does not help the students improve their academic performance during the school term.

The '9167 publication only evaluates students based on typical testing results and does not provide timely frequent periodic performance improvement of the students as they perform in a classroom.

The '1193 publication is a management information system that only provides tutoring services external to an institution and its students. It does not evaluate the ongoing performance of students in such institutions or identify such students at the time they need tutoring.

Others of the above references also are believed by the present inventors as not being sufficiently effective in disclosing tools to improve the academic performance of a student in an effective manner during an educational institution term.

A tutoring management method according to an embodiment of the present invention is for an educational institution having an administration, student advisors, instructors, and a Learning Center for providing tutoring and an early identification of the students with academic problems to the institution staff and to the students.

The method comprises requiring all instructors to assign and record in a data base the academic grades of each of their students on a frequent periodic basis in each of a plurality of a predetermined grade areas correlated to the student's efforts in a class room at learning the involved course subject, to monitor the performance of each said student on a frequent periodic basis during a given academic term, and to require all students at academic risk having a grade in any of the grade areas below a predetermined level to attend tutoring.

Also the method requires the instructor to assign a tutor which may include that instructor or other tutors to each such student at risk and monitor the progress of that student being tutored and enter such into the data base.

The method includes permitting each such tutored student, instructors, administration, advisors and students to access the progress of each such student at any time as entered in the data base.

The method further includes the step of providing periodic reports as to the academic progress of such tutored students to administration, advisors, students and instructors which reports report to administration all instructors not in compliance with requiring students to attend at least one tutoring session and not in compliance with requiring the arrangement of the tutoring of each such student at risk based on data entered in the data base.

In a further embodiment, providing the predetermined grade areas such that they include class participation, required reading, quizzes, answering questions in class, and assignments/homework.

In a further embodiment, the predetermined grade areas step includes class participation, required reading, quizzes, answering questions in class, and assignments/homework and the periodic assignment of grades is on about a weekly basis.

In a further embodiment, the periodic reports include emailing summary reports to the instructors of students at risk.

In a further embodiment, the periodic reports include providing automated emails to students requiring tutoring.

In a further embodiment, the periodic reports include providing automated email notification to the instructors with respect to students at risk requesting the instructors to schedule tutorials for such students.

In a further embodiment, counselling the students with advisors, the method including permitting the advisors to access the data base and to receive automated email notifications as to students at risk including summary and detailed reports of evaluated students at risk.

In a further embodiment, the periodic reports include providing automated email notification summary reports to the administration with respect to students at risk for whom tutoring is required.

In a further embodiment, providing the institution as a school of higher education having departments specializing in different areas of study, the method including providing multiple school campuses, each having student advisors, departments, instructors, subjects and students, wherein the notification to administration is a summary report listing for a given campus and department including each subject for each student at risk.

In a further embodiment, the method comprises permitting the advisors to access the data base and to having them provide a periodic progress report with comments as to students at risk or report whether or not all attending students are at risk.

A further embodiment includes providing a computer screen listing a schedule of new tutoring with a view of pending sessions listing student, instructor, advisor, tutorial assignment, and status.

A further embodiment includes providing a computer screen for advisors use displaying a schedule of student's tutoring, for all students whether or not needing tutoring, having a home page, a weekly progress report, and other reports, an arrangement for selecting student, the week involved, entering comments, dates and campus.

A further embodiment includes the step of providing a computer screen for subject mapping of available subjects and listing assigned subjects.

A further embodiment includes the step of providing a computer screen for providing a tutoring schedule for tutors listing department, instructor and days/times assigned.

In a further embodiment, included is the step of providing a computer screen for providing a list of reports that are available including a summary of students at risk by instructor, by advisor, by program of study, by admission rep, non-compliant instructors, summary tutorials outcome, term summary students at risk by admission rep, term students with grades below B by program, term students with grades below B by department.

In a further embodiment, the advisors have access to the data base, including providing a drill-down report for providing a weekly summary of students at risk by advisor, or by instructor, and by program of study. A drill-down report is a well known term of art in the computer field. In such a report there are different levels involved. For example, the present embodiment, the school administration is the top level, the departments are the next level, the teachers are the next level and finally the students are at the lowest level. The report can be expanded to each level to further show details at the expanded level.

In a further embodiment, included is the step of providing a drill-down report for providing a display of non-compliant instructors illustrating the percent of not evaluated classes.

In a further embodiment, included is the step of providing a computer screen for providing a display of a drill-down report that can be opened at the student level providing a summary of tutorials outcome.

In a further embodiment, included is the step of providing a drill-down report for providing a display of term students with grades below B by department.

In a further embodiment, the drill-down report includes students/courses by program with grades below B, were at risk at least once, total provided tutorials, cumulative attendance, final grade and midterm grade.

In a further embodiment, included is the step of providing a Learning Center in which students, professional tutors or instructors serve as tutors for walk in students requesting tutoring, students assigned tutoring from part time instructors or other students in need of tutoring on an ad hoc basis.

A tutoring management method for an educational institution having an administration, instructors, advisors and students in a still further embodiment comprises requiring all instructors to periodically monitor and record in a data base the student academic standings in grade form for a plurality of class work criteria for all courses of instruction and for each student.

Also, the method requires that each instructor be mandated, for each student whose academic standing falls below a given predetermined academic grade level of any of the predetermined grade levels, a grade below the predetermined level manifesting a student at risk, to require that student to attend a tutoring program for each such course and enter that requirement in the data base.

For each such instructor having a student attending the tutoring program, tutoring or arrangement for the tutoring of that student is provided and records that information in the data base.

Included is periodically monitoring the progress of students attending the tutoring program via accessing the data base.

The method includes monitoring and recording in the data base all instructors not complying with the mandating step, not providing the tutoring or not arranging a tutor for a student at risk.

The method includes providing each student, instructor, advisor and the administration access to the data base and providing periodic reports to such persons of the academic progress of each student for each course of instruction taken by such student.

The method also includes recording in the data base instructors not in compliance with the mandate; and provides periodic reports to the administration of such non-complying instructors.

In a further embodiment, the method includes providing a Learning Center for providing tutoring to the students at risk and others, the Learning Center includes tutors comprising students, instructors and professional tutors for receiving and tutoring students assigned thereto and other individuals requesting tutoring or assigned tutoring by a part time instructor or others.

In a further embodiment, a tutoring management method is provided for an educational institution having administration, instructors, advisors and students comprises requiring instructors to periodically on a frequent basis during a term assign each of their students a grade in a plurality of different criteria correlated to student performance in a class room environment with respect to a given course subject, and enter such grade into a data base.

The method requires instructors to assign tutoring to each of their students having a grade below a given threshold level for a plurality of classroom criteria on a periodic basis that puts the student at academic risk and enter that information into the data base.

The method automatically notifies management of non-compliant instructors with respect to assigning grades or tutoring to students at risk and notifying instructors, students, advisors, and automatically notifying management regarding the result of frequent periodic student evaluations in each course of study with respect to the different criteria.

In a further embodiment, the frequent basis for assigning students a grade in the plurality of classroom criteria is weekly, and the frequent periodic notification of management of student evaluations is daily.

In a further embodiment, the plurality of different criteria for grading a student on a weekly basis is class room participation, homework/assignments, answering questions during class, required reading and quizzes,

### IN THE DRAWING

FIG. 1 is a diagrammatic block diagram illustrating a work flow chart according to an embodiment of the method of the present invention;

FIG. 2 is a block diagram of the communication system according to the embodiment of the present invention;

FIG. 3 is a diagrammatic block diagram illustration of the method of the present invention according to the embodiment of FIG. 1 in more detail;

FIG. 4 is a diagrammatic block diagram illustration of the method of the present invention according to the embodiment of FIG. 3 in more detail in respect of one aspect of FIG. 3;

FIG. 5 is a diagrammatic block diagram illustration of the method of the present invention according to the embodiment of FIG. 3 in more detail in respect of a further aspect of FIG. 3;

FIG. 6 is a log in computer screen page for logging into a private intranet system of an educational facility;

FIG. 7 is a computer screen of a weekly progress report form illustrating student tutoring progress;

FIG. 8 is a computer screen illustrating an email notification summary report for an instructor;

FIG. 9 is a computer screen illustrating automated Email notification to a student;

FIG. 10 is a computer screen illustrating automated Email notification sent to an instructor;

FIG. 11 is a computer screen illustrating automated Email notification sent to an advisor;

FIG. 12 is a computer screen illustrating an Email notification summary report sent to an advisor;

FIGS. 13, 14, 15 are computer screens illustrating an Email notification summary report sent to administration;

FIG. 16 is a computer screen illustrating advisor comments on weekly progress report;

FIG. 17 is a computer screen illustrating schedule new tutoring (view pending sessions);

FIG. 18 is a a computer screen illustrating a schedule of student's tutoring;

FIG. 19 is a computer screen illustrating tutor-subject mapping;

FIG. 20 is a a computer screen illustrating tutoring schedule for tutors;

FIG. 21 is a a computer screen illustrating available reports listing;

FIG. 22 illustrates a report sample, a tutoring log by tutorial status;

FIG. 23 is a drill-down report illustrating weekly summary students at risk by advisor;

FIG. 24 is a drill-down report illustrating summary of students at risk by instructor;

FIG. 25 is a drill-down report illustrating summary of students at risk by program of study;

FIG. 26 is a drill-down report illustrating non-compliant instructors with percent of not evaluated classes;

FIG. 27 is a computer screen illustrating analysis reporting with drill-down report that can be opened to the student level; and

FIG. 28 is a computer screen illustrating term students with grades below “B” by department.

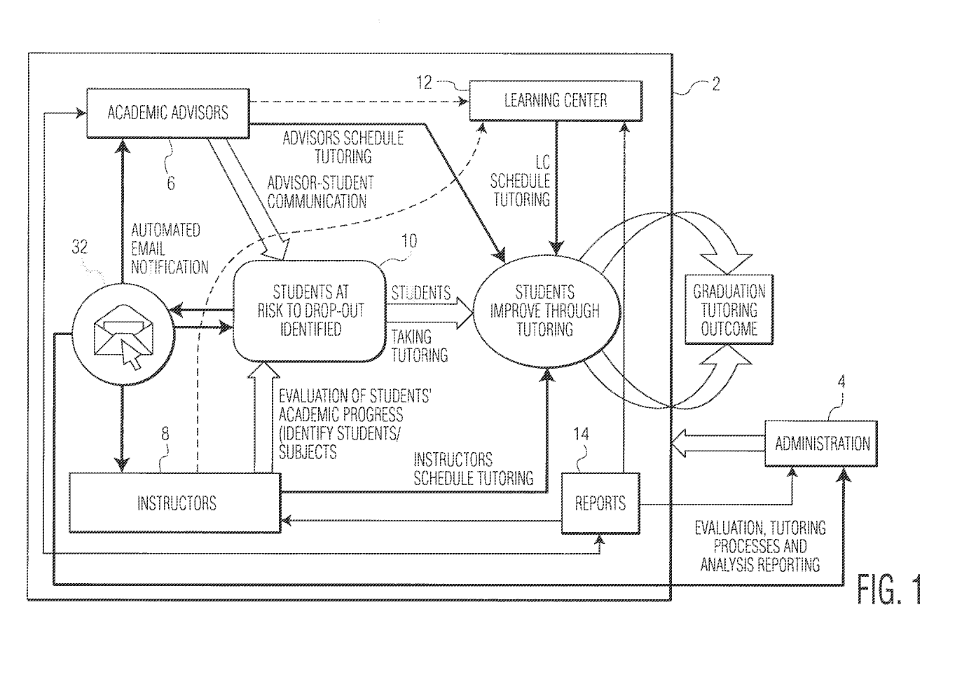

In FIG. 1, a tutoring management system 2 according to an embodiment of the present invention, work flow comprises administration 4, academic advisors 6, instructors 8, students 10 identified as being at academic risk, a Learning Center (LC) 12 and reports 14. Generally the instructors 8 schedule tutoring for those students 10 at academic risk. The Learning Center 12 is also used to tutor students at risk who may not be assigned to tutoring by their instructor.

By academic risk is meant that for each instructor of one or more courses of subject matter being taught, each course being taught in a class room environment of one or more students, typically a plurality of students, the instructor must grade each student in each course on a predetermined periodic basis for a plurality of classroom criteria. That classroom criteria comprises 1) class participation, that is, how well does the student participate during a class instruction, 2) performance of required reading, 3) quizzes periodically given during a school term, 4) how well the student answers questions given by the instructor, and 5) the students completion of assignments and/or home work. While these criteria are required in a preferred embodiment, it will occur to one of ordinary skill that more or fewer criteria may be employed to define a student at academic risk.

For each such criteria 1-5, the instructor must assign a grade to each of his students on a frequent periodic basis. In the present embodiment, the grade must be assigned weekly. However, the period could be less than one week or more than one week. Of course, assigning such grades is an additional burden on the instructors and thus the frequency of the period of assigning the grade is a balance of such a burden with the desired effectiveness of the tutoring system in improving student performance during a school term.

The inventors believe that a one week period to be reasonable, but realize that other periods of grade assignment may also be effective. Therefore, it is believed that assigning such grades in about weekly periods is optimum to catch a student at academic risk early in the school year. Other periods might also be effective to accomplish the goal of catching academic at risk students early and often during a school term in accordance with a given implementation.

In the present embodiment, a student at risk is one whose assigned grade in each of the class room criteria 1-5 being evaluated is below “B” wherein the academic grades in the institution are A, B, C, D, and F. Of course widely used numerical grades could be employed instead as desired. A student 10 who has a grade below “B,” or any other desired threshold level, in any of the criteria areas 1-5 defined above, are deemed to be “at risk.” However, as described below, a student at risk may be one based on his or her attendance.

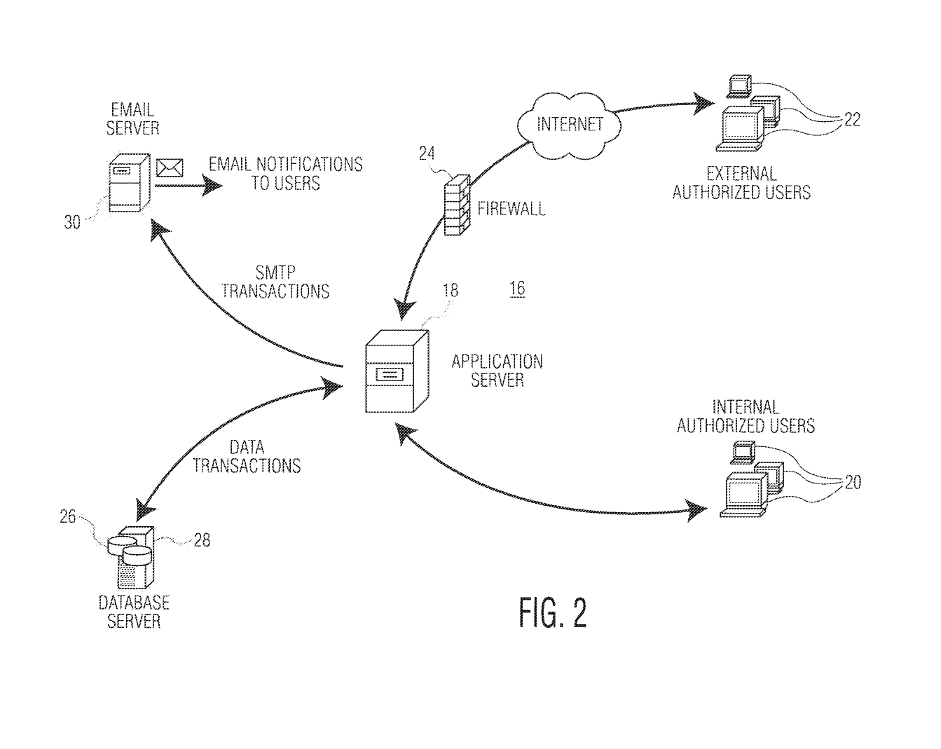

In FIG. 2, the communication system 16 comprises an internal private intranet application server 18 operated by the institution and private to the institution internal authorized users 20. As known, internal users are assigned user IDs and passwords to access the server 18. The authorized users use institution or personnel owned computers 20. External authorized users using personal computers 22 have access to the server 18 via the publically available internet through an institution provided firewall 24 and also have assigned user IDs and passwords. The server 18 communicates with database 26 via database server 28. The application server 18 provides SMTP (small mail transaction protocol) transactions to an email server 30. The server 30 sends email notifications to users as explained below.

The instructors 8, FIG. 1, as authorized users, enter the assigned grades via their computers 20 to the database 26 via the intranet provided by the application server 22. These assigned grades are entered by the instructors about weekly. Students whose grades fall below “B” are identified at risk and are required to attend tutoring. The tutoring is provided by the instructor, or by the Learning Center 12. In case of part time instructors, they may not be available for tutoring so they assign their students to the Learning Center 12.

The Learning Center 12 tutoring staff comprises professional tutors employed by the institution, qualified students, or instructors. The Learning Center 12 tutors students assigned to it by instructors, walk-in students desiring tutoring or others in need of tutoring as may be required.

Automated email notifications are sent advising students at risk to attend tutoring and to advisors administration and to the Learning Center reporting such students as applicable. The advisors 6 communicate with the students 10 at risk and schedule tutoring as applicable to certain of the students 10. The progress of the tutoring of the students is monitored via the system 16 by specific periodic reports 14 to be described below sent to the Learning Center, instructors 8, advisors 6, and administration via email notifications 32.

It has been observed that students participating in the tutoring system have noticeable improvement in response to such tutoring wherein it is believed that a higher percentage of at risk students 10 will reach graduation not otherwise possible. All students are evaluated by this system and all students evaluated as being at risk are notified of such by email as well as their instructors, department chairs, advisor chair, and administration.

The instructor fills out an assignment for tutoring via two possible options:

1) To assign tutoring to him or herself, either immediately or after contacting the student and thus becomes a “scheduled tutoring” for that student.

2) To send the student for the tutoring to the Learning Center. In this case, the advisor is notified of this condition and has to contact the student, and schedules the tutoring. This information is entered into the database by the instructor and advisor. The instructor can view the advisors comments entered into the system database on a weekly progress report to be described.

Students that come to the Learning Center or to the instructors and were not identified as a “student at risk” on the current week, can also get tutoring that will be reflected in the database.

After providing the tutoring, the instructor (or the Learning Center tutor) has to fill out the “after tutorial comments” and change the status of the tutorial to “provided.” An instructor can provide the tutoring to the students from his or her class or to the other instructors students. The instructors can control the tutoring with different statuses by running reports titled: Tutorial Log by Tutorial Status' as described below.

Others of the reports are available to the department chair persons, the Learning Center, and the administration for analysis of the effectiveness of the process.

Each week student performance is tracked for every student in each course. For students earning below “B” grade, instructors are required to report on the several criteria noted above and indicate what tutoring topics have to be covered for that student. Advisors use the reports to contact students to help resolve issues and make tutoring appointments for students at risk or others. Faculty and tutors access information on each student for targeted tutoring and report on each session. Detailed and summary reports are generated for administration, instructors, Learning Center, and advisors to monitor student progress, by course, by program and other parameters. The success of this effort is believed to be demonstrated by a graduation rate of 35% for highly at risk students.

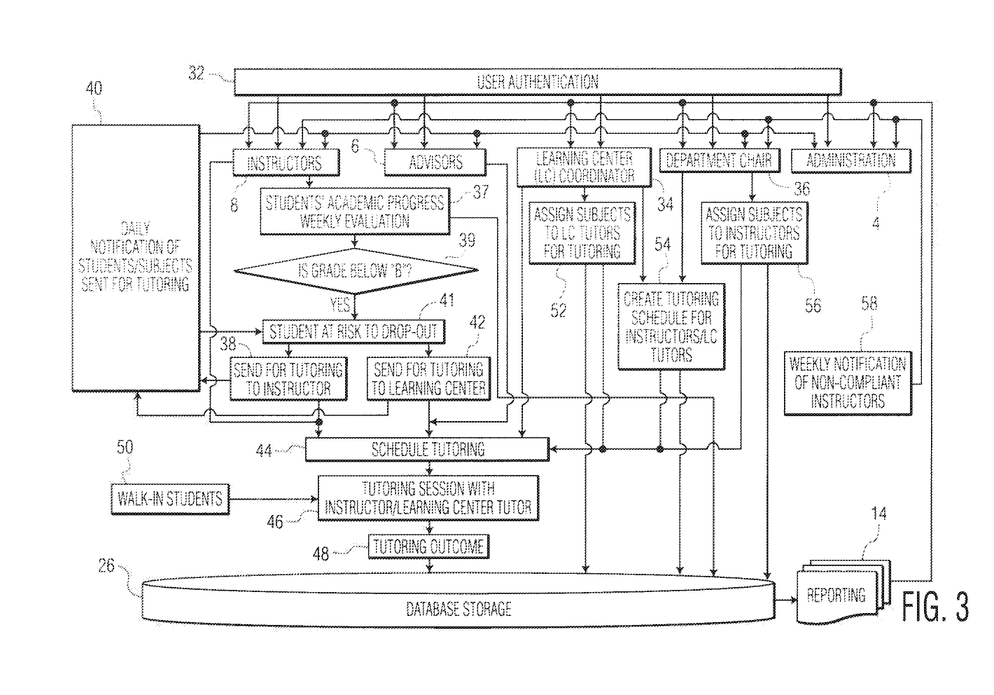

In FIG. 3, a more detailed flow diagram illustrates the various aspects of the system according to the present embodiment. User authentication 32 comprising log in of user IDs and passwords are assigned to instructors 8, advisors 6, Learning Center coordinator 34, department chair 36, and administration 4.

The instructors 8 provide and enter into the data base 26 weekly progress academic evaluations (grades for each of the five criteria above) of each of his/her students, step. If the grade is below “B,” step 39, the student 10 is placed at risk to drop-out of school, step 41. That student 10 is sent for tutoring by the instructor 8 at step 38 or the student is sent to the Learning Center 12 at step 42, which results in a notification email 40 to all. If sent to the tutoring by the instructor, daily notifications 40 are issued to the students, advisors, Learning Center coordinator, department chair (as applicable) and administration for the students/subjects sent for tutoring.

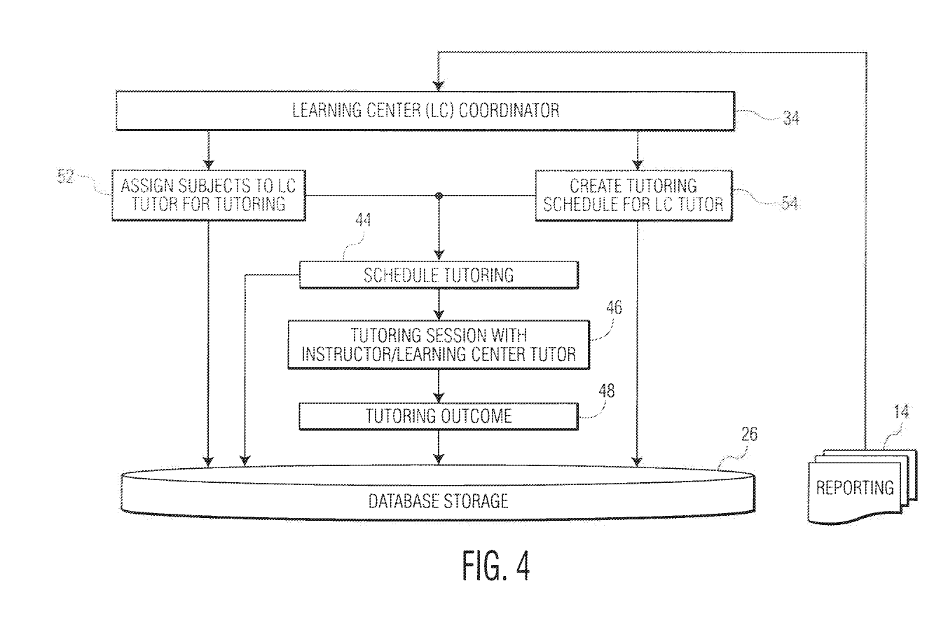

In FIGS. 3 and 4, if the student is sent to the instructor for tutoring, step 38, or to the Learning Center 12 coordinator 34 for tutoring, step 42, the coordinator creates a tutoring schedule for the LC tutor, step 54 and tutoring is scheduled at step 44 by the Learning Center coordinator 34 or the instructor 8 as applicable. Tutoring is provided either by an instructor of by a Learning Center tutor at step 46. The outcome of such tutoring is reported to the database 26, step 48.

Walk-in students 50 also may request tutoring at the Learning Center (LC), step 46.

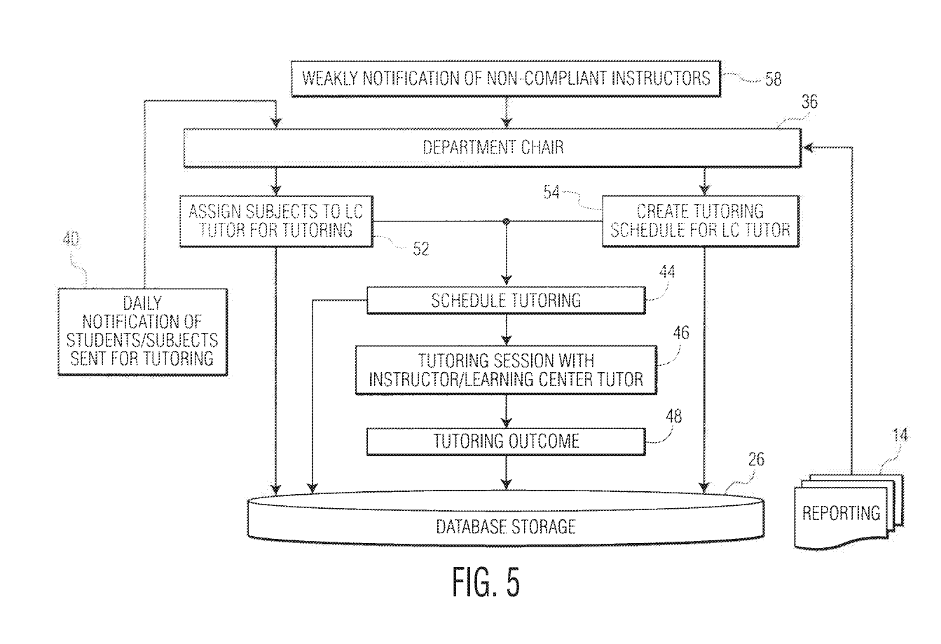

In FIG. 5, the department chair 36 (if applicable to a given institution) receives weekly notification 58 of non-compliant instructors. The chair 36 assigns subjects to the LC tutor for tutoring, step 52 and creates a tutoring schedule for the LC tutor, step 54. The schedule for tutoring 44 is made in response to the assignment of subjects to LC 52 and after the tutoring schedule 54 is created for the LC tutor. All of the above steps 52, 54, 44, and 48 are entered into the database 26. The reports 14 are generated based on the data in the database,

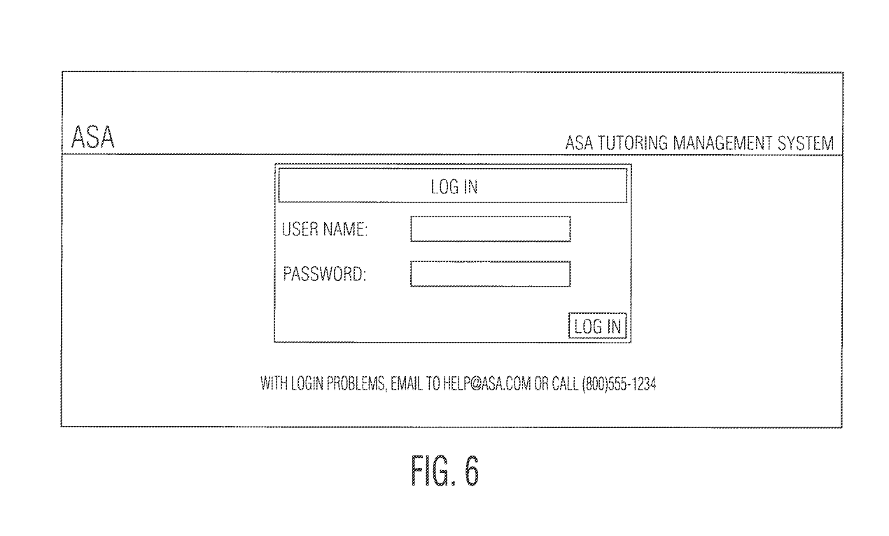

FIG. 6 is a log in computer screen for logging into the system 16, FIG. 2.

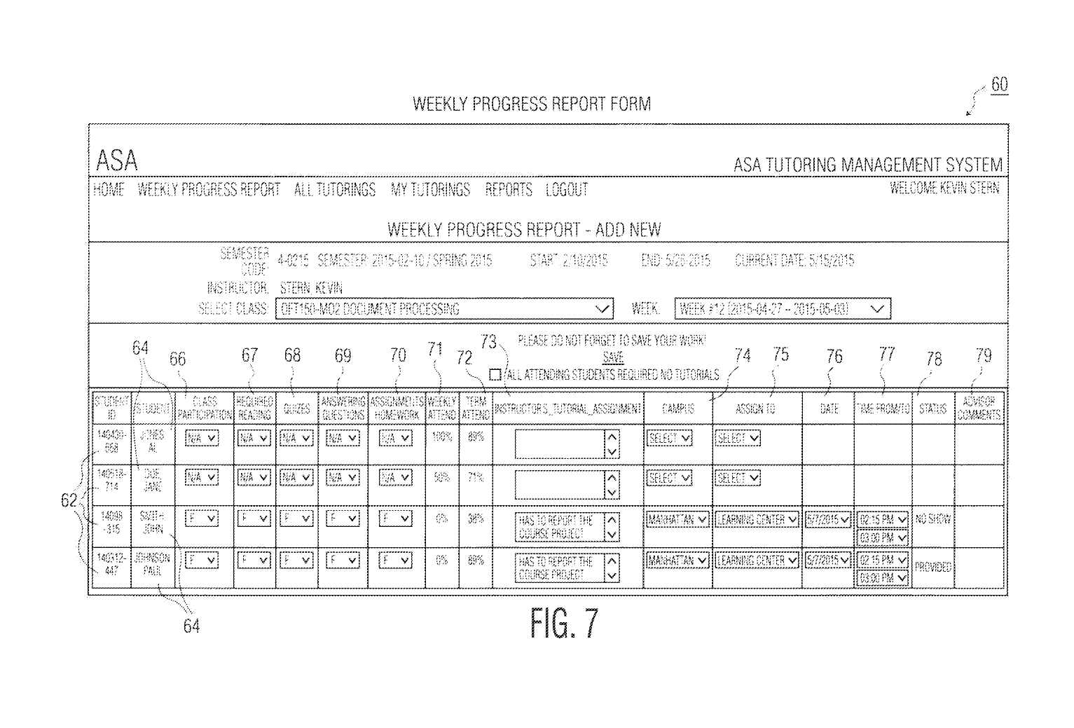

FIG. 7 illustrates a computer screen 60 displaying a Weekly progress report. This report identifies students by ID no. 62 and by name 64 (all names crossed here and in all other figures to protect individual privacy). Grades are entered for class participation 66, required reading 67, quizzes 68, answering questions 69, assignments/homework 70, weekly attendance 71, term attendance 72 and instructor's tutorial assignment 73. The campus is designated 74, the tutor assigned is listed 76, date is at 76, times of tutoring at 77, status 78 (e.g., “no show”) and advisor comments 79.

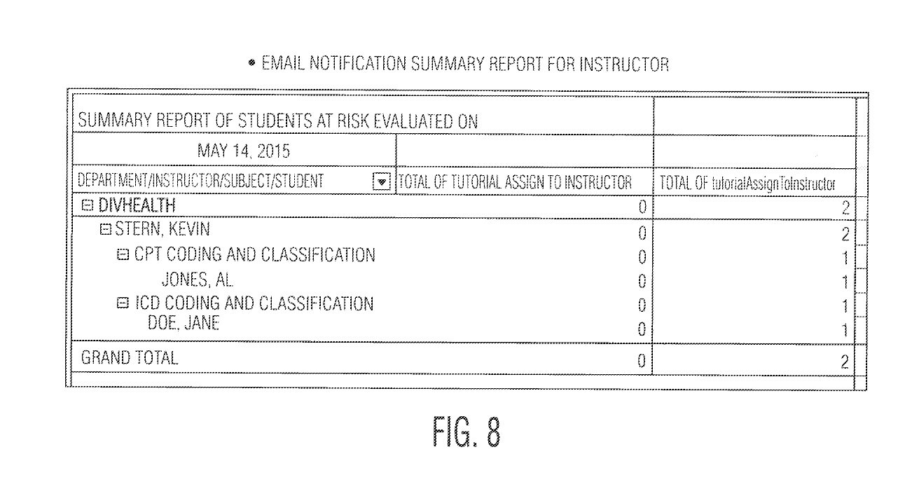

FIG. 8 is an email notification summary report for instructor reporting students at risk evaluated on a given date listing department, instructor, subject and student.

The advisors 6 may also schedule tutoring at step 44. The Learning Center (LC) coordinator 34, FIGS. 3 and 4, assigns subjects to the LC tutors for tutoring at step 52 which data is entered into the database 26 by the coordinator. The LC coordinator 34 also creates tutoring schedule for the instructors 8 or the LC tutors, step 54, and which is entered into the database 26. The Advisors 6 may also schedule students for tutoring at step 44. The department chair 36 (as may or may not be applicable for a given institution) assigns subjects to instructors for tutoring, step 56, and then the tutoring is scheduled at step 44, both steps being entered into the database 26.

A weekly notification report of non-compliant instructors who do not assign the weekly grades, or who do not assign tutoring to their at risk students 10, steps 38 or 42, or who do not provide tutoring, step 46, if assigned such and so on, is sent to administration 4, an applicable department chair 36, the applicable advisor 6, the LC coordinator 34 and to the instructors 8 at step 58. Applicable relevant reports 14 are generated by the system 16 servers, FIG. 2, and related programs from the database data 26 and sent to the instructors 8, advisors 6, LC coordinator 34, department chair 36 and administration 4.

In summary, the instructors 8 evaluate the students' academic progress on a preferably weekly basis in five classroom areas:

a) class participation

b) required reading performance

c) quizzes

d) answering questions in class

e) assignments/homework

by filling out the weekly progress report, FIG. 7. Students with grades below “B” create a group of “students as risk” 10 to drop out of school and are assigned for tutoring either with and by the instructor 8 or in the Learning Center 12. The next day, automated emails are sent:

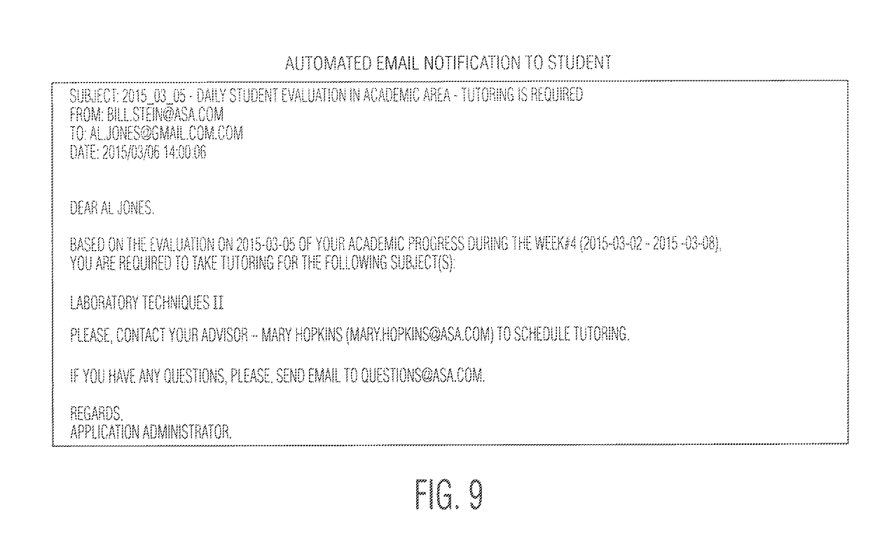

a) to the students 10, FIG. 9, with the list of subjects they are encountering academic problems with and thus are required to attend tutoring;

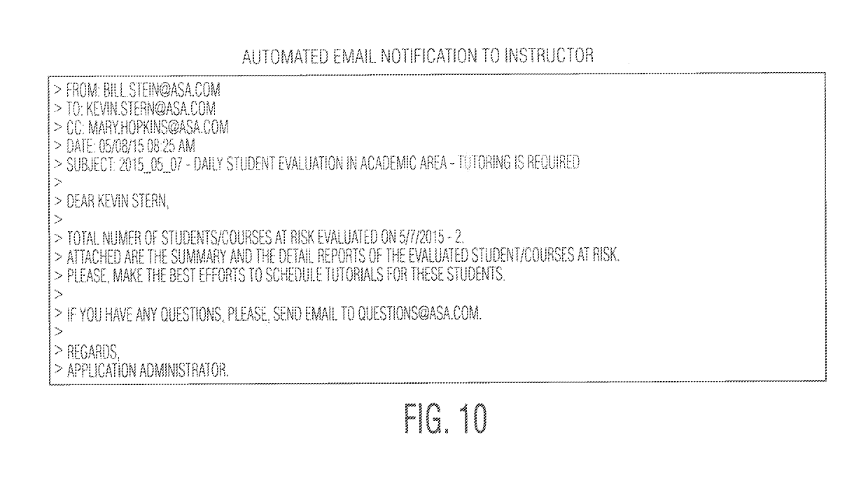

b) to the instructors 8 with the attached report, FIG. 10, of the students/subjects assigned for tutoring;

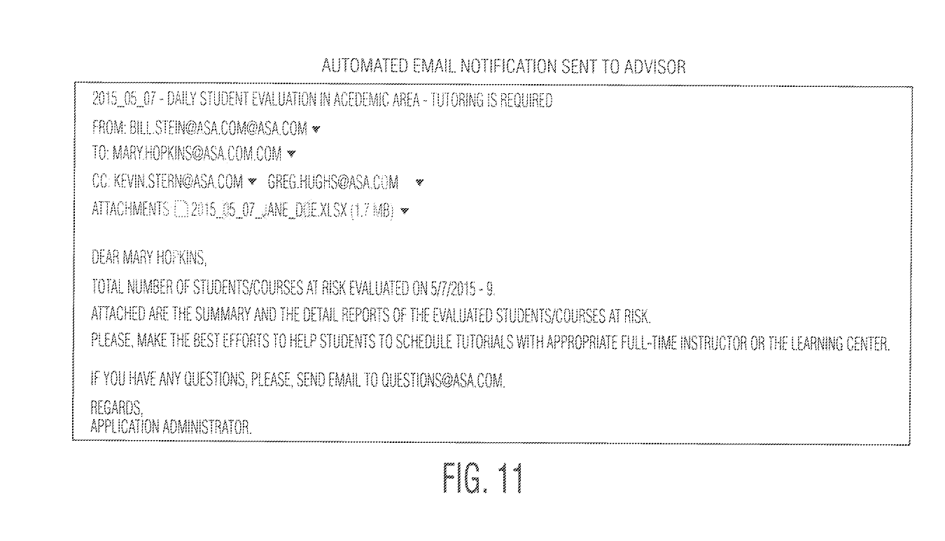

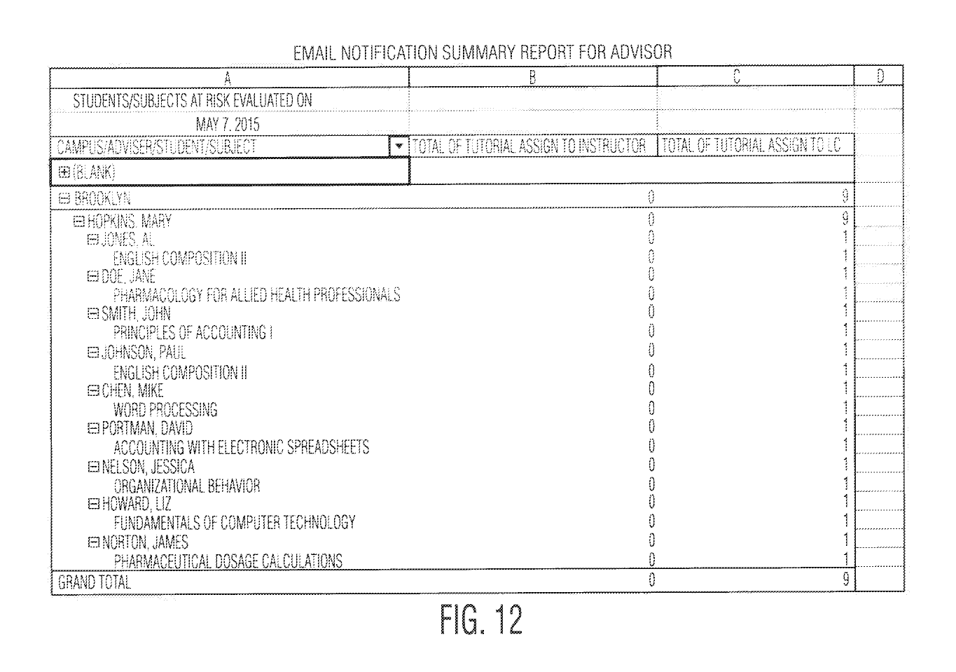

c) to the advisors 6 with the attached report, FIG. 11, of students assigned to these advisors and assigned for tutoring,

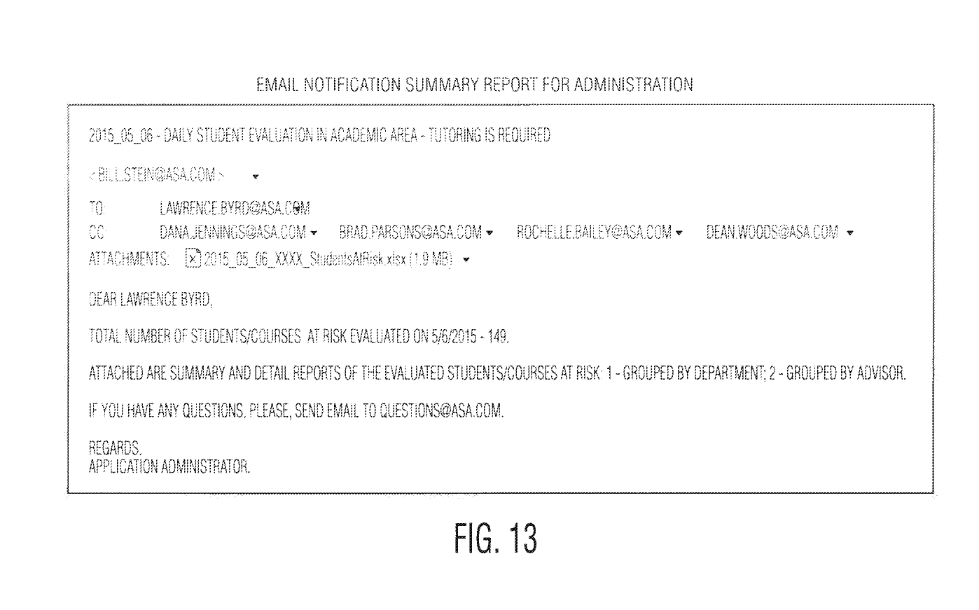

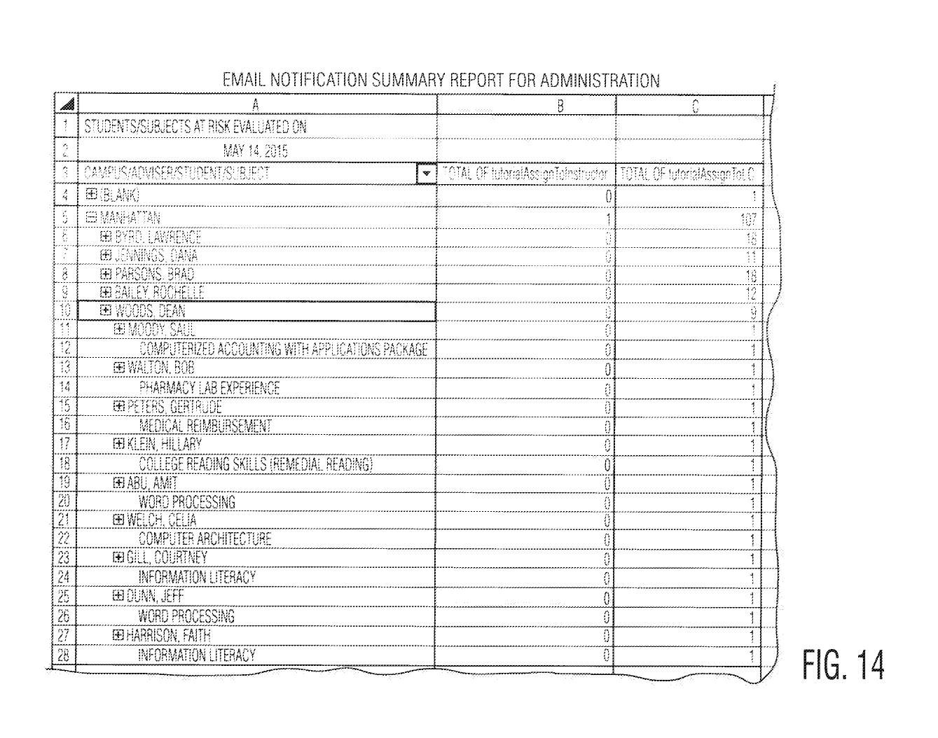

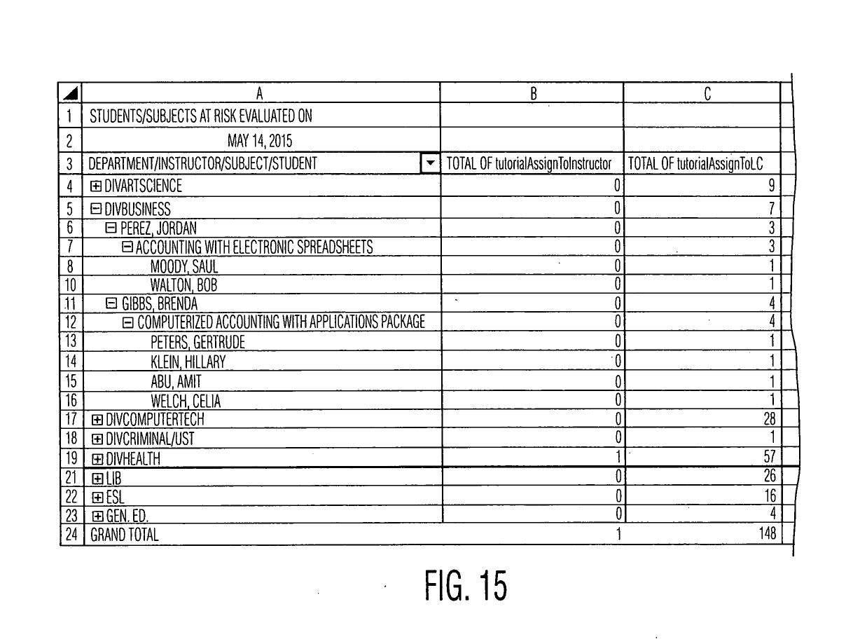

d) to administration 4, FIGS. 13, 14 and 15, including department chairs with the attached report of students assigned for tutoring grouped by department; instructor, subject, and student.

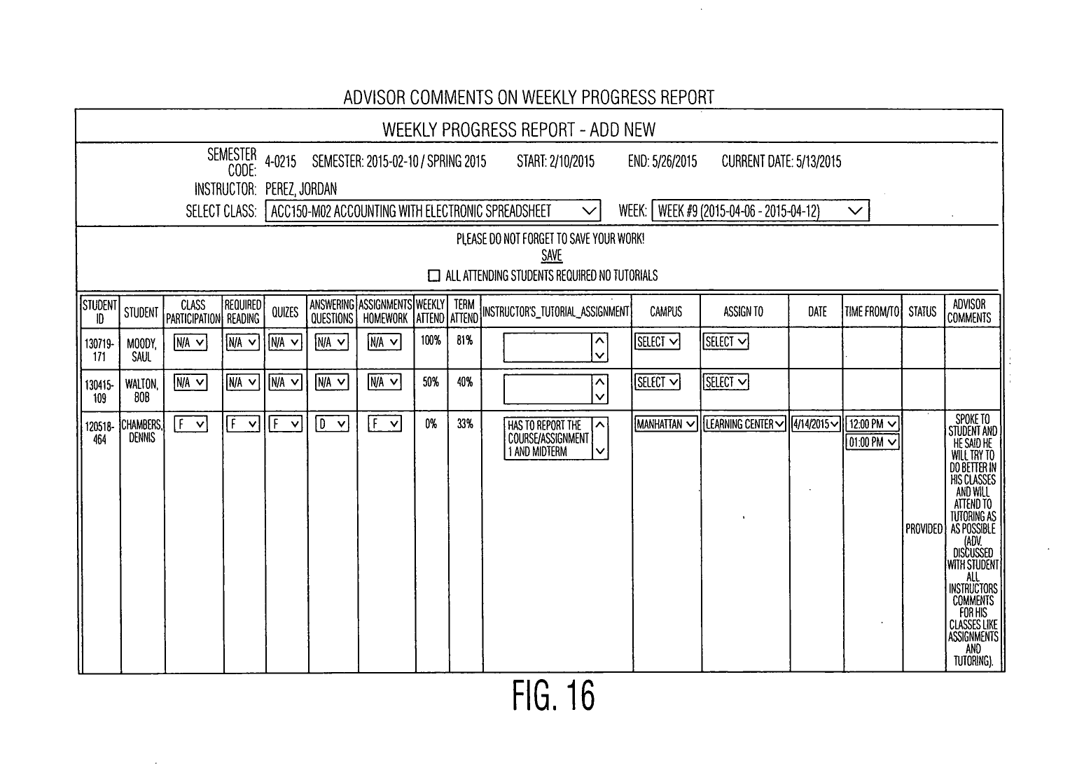

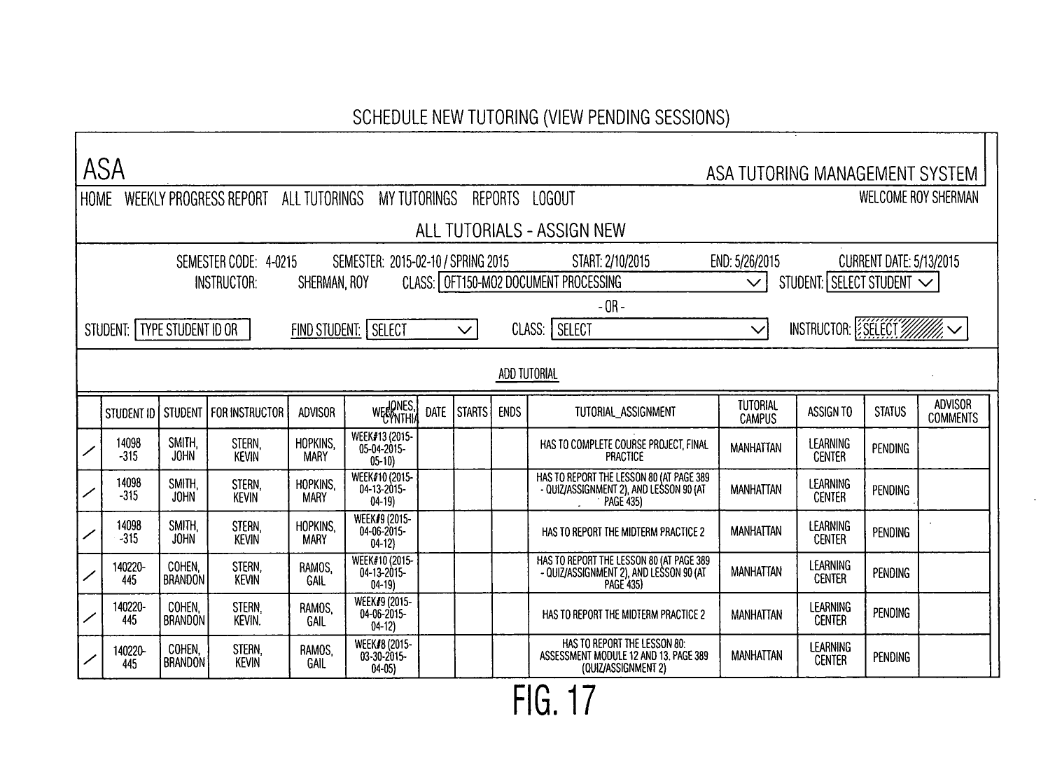

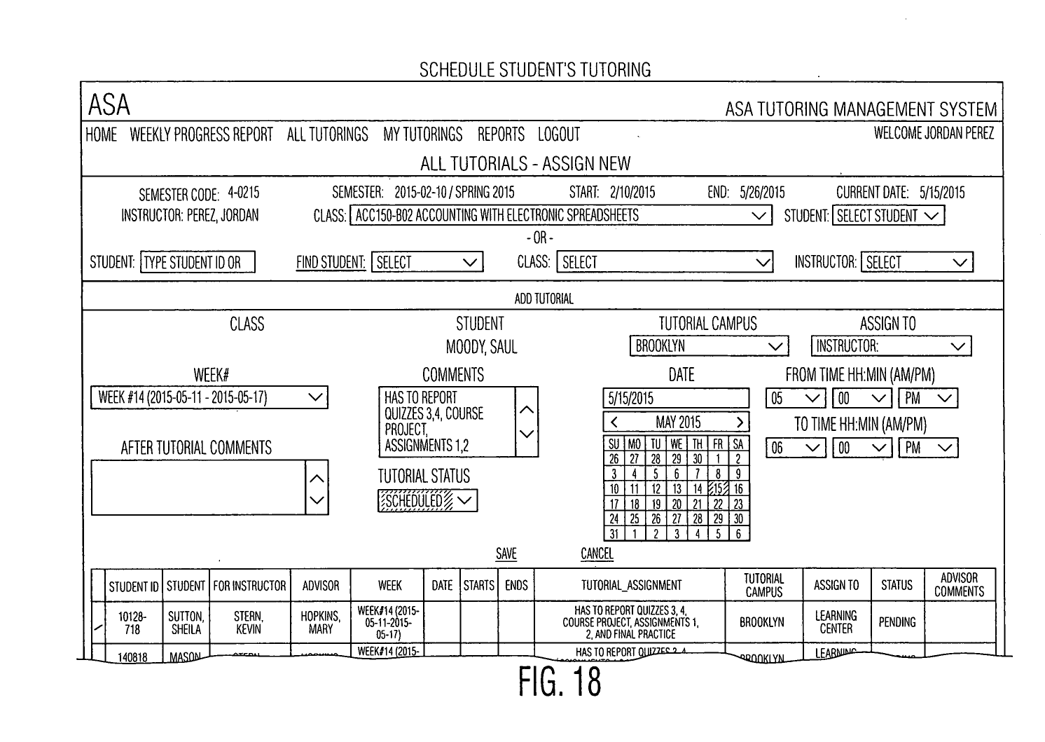

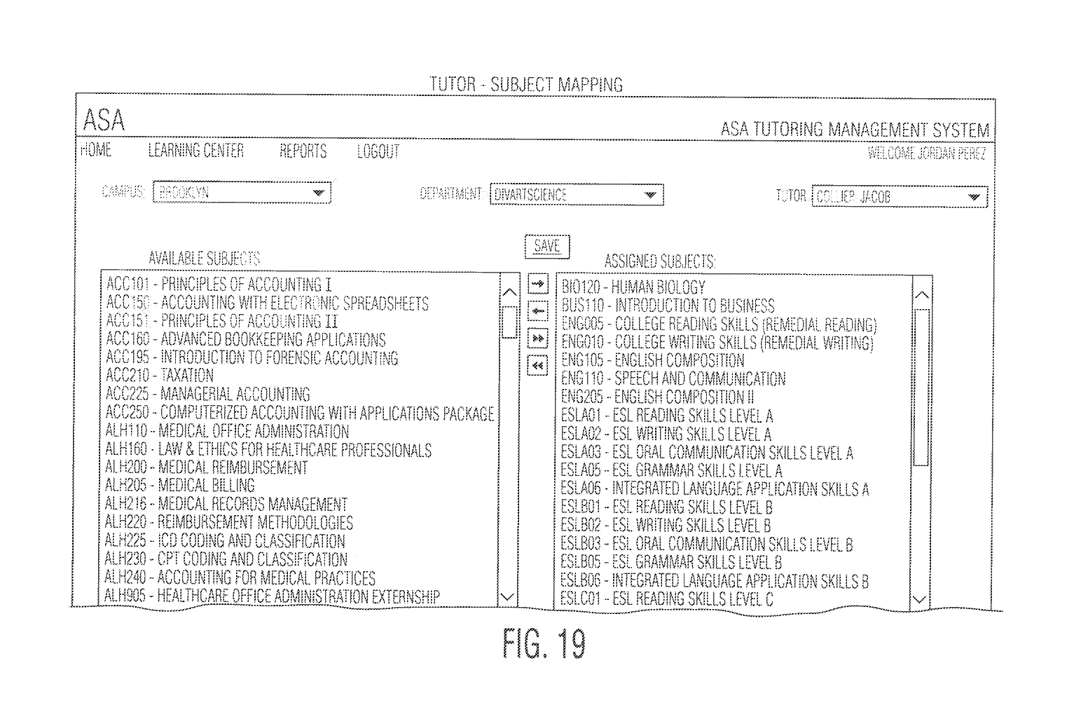

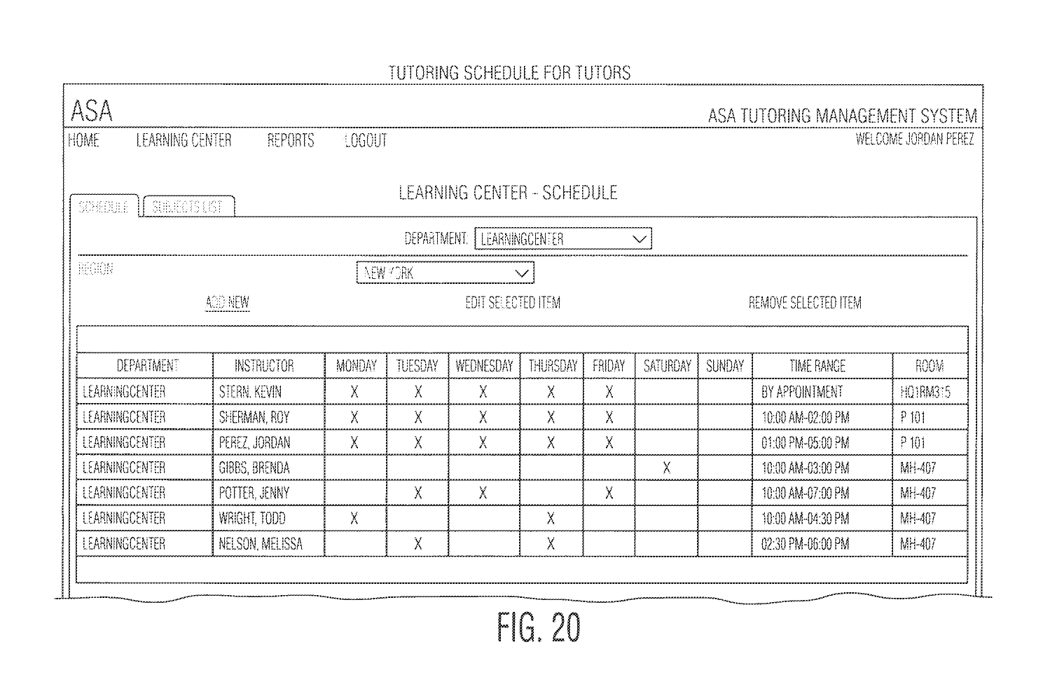

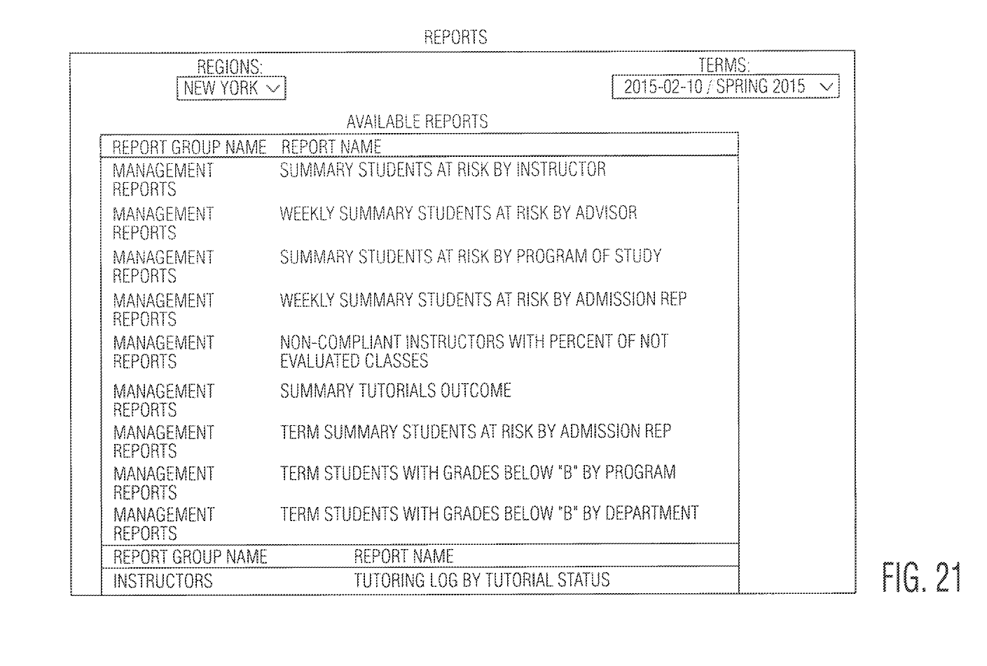

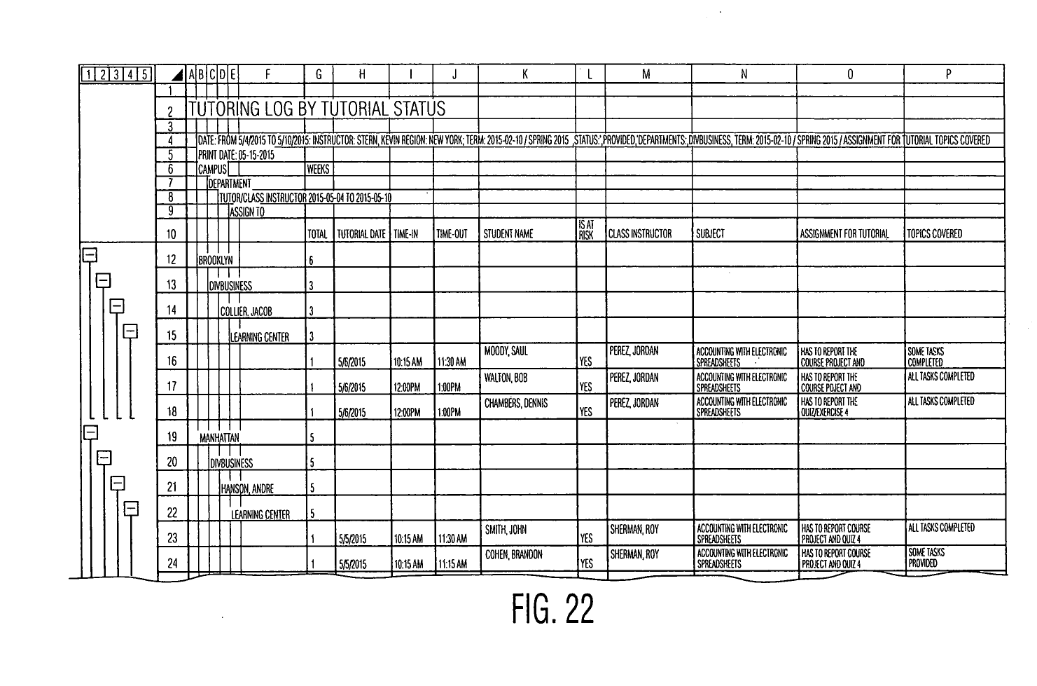

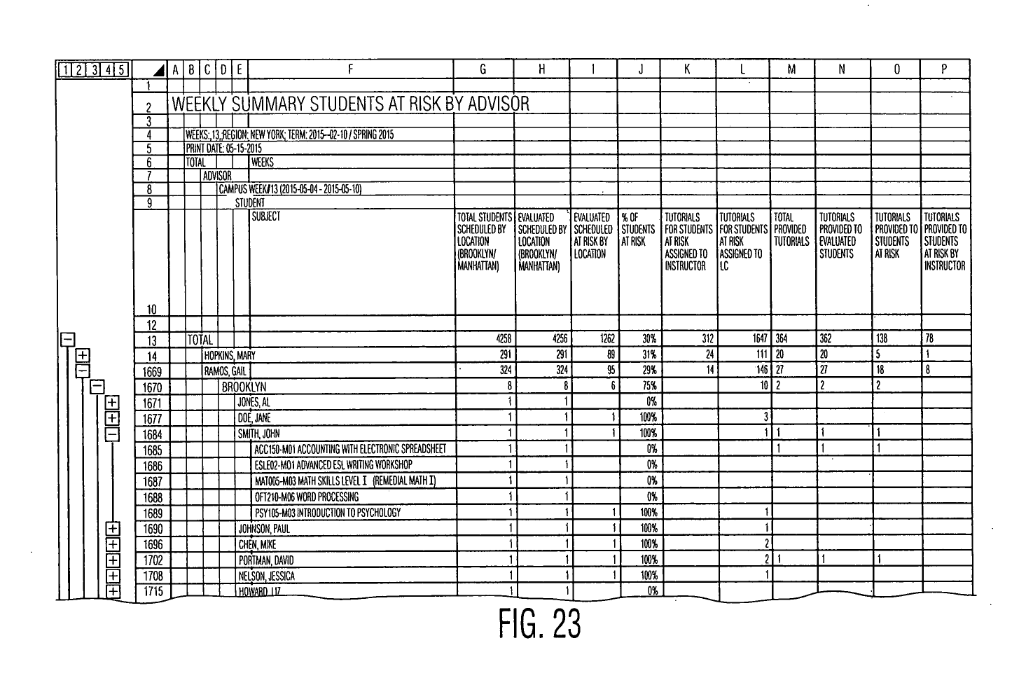

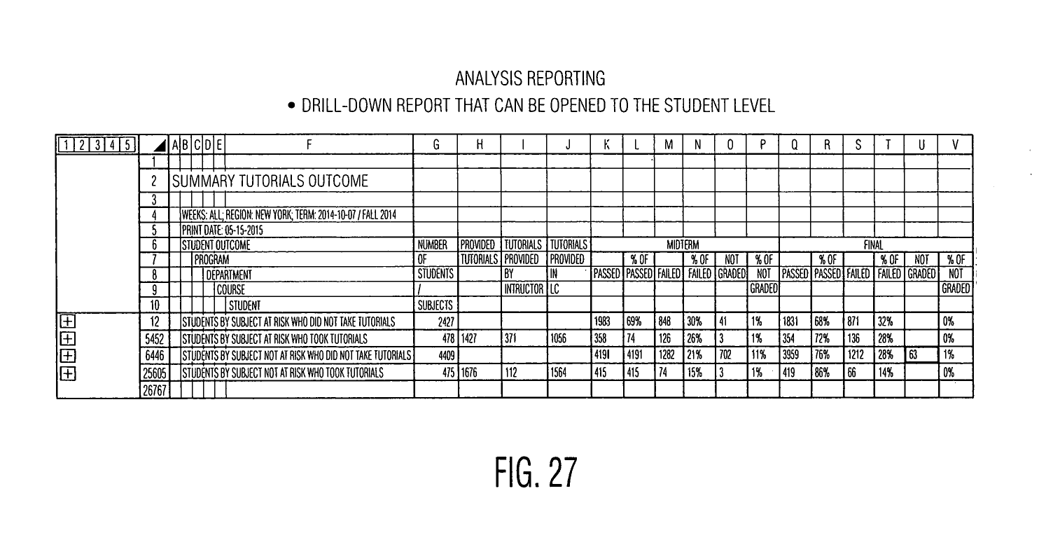

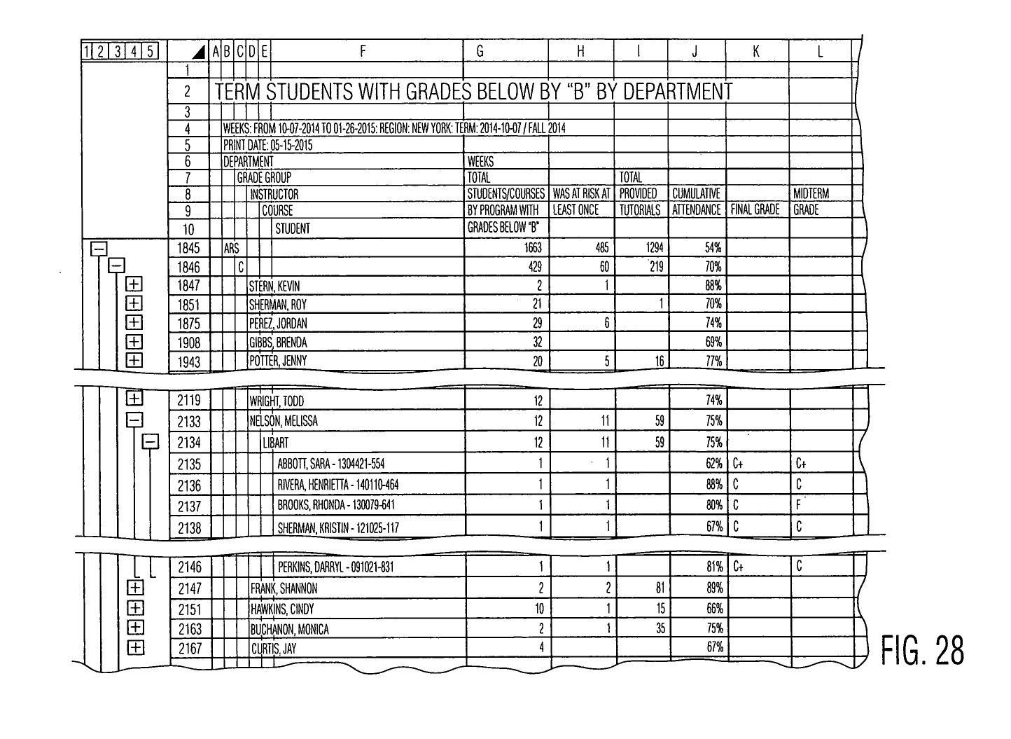

Advisors 6 working with the students that are assigned for tutoring and also with the students 10 with low cumulative attendance to return them to school and schedule the tutoring sessions. They enter their comments in the evaluation report, FIG. 16, via the system 16 database 26 via the database server 28, FIG. 2. Instructors 8, advisors 6, and Learning Center 12 tutors can schedule the tutoring sessions for the students 10 at risk and also for walk in students who request tutoring regardless academic standing, FIGS. 17 and 18. The list of tutors is based on the tutor/instructor-subject mapping created by the department chairs or Learning Center coordinators, FIG. 19. The schedule for tutoring for the tutors is also set up by the department chairs 36 or the Learning Center coordinators 34, FIG. 20. After tutoring is provided, the tutor changes the status of the tutoring session to “provided,” fills out the outcome comments and closes the tutoring session which is then entered into the applicable report by the system 16. Tutoring outcome is analyzed based on the “weekly progress reports,” FIGS. 7A and 7B, and the midterm and final exams. The administration 4 monitors the entire process, analyzes the tutoring outcome, FIG. 27, using the reporting tools and makes modifications to the process if necessary.

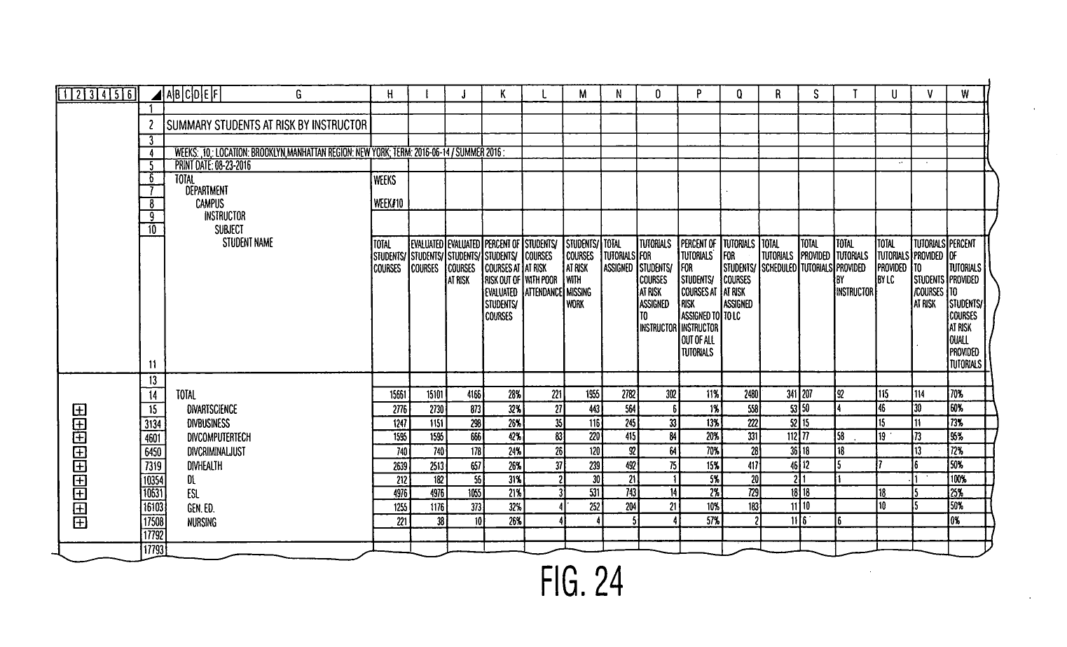

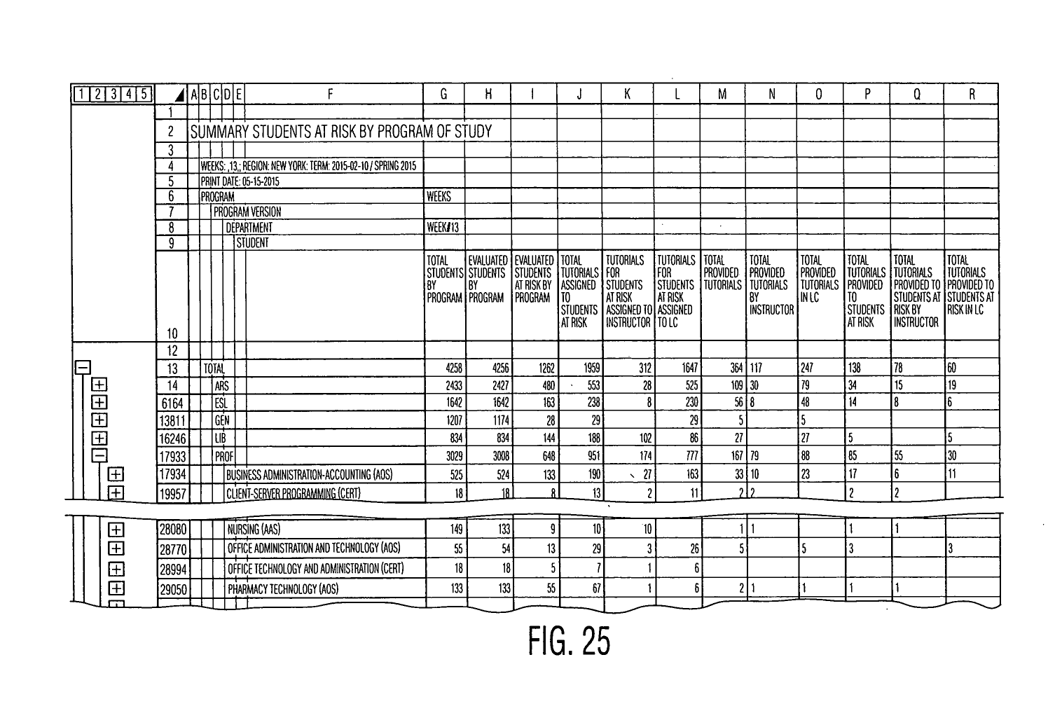

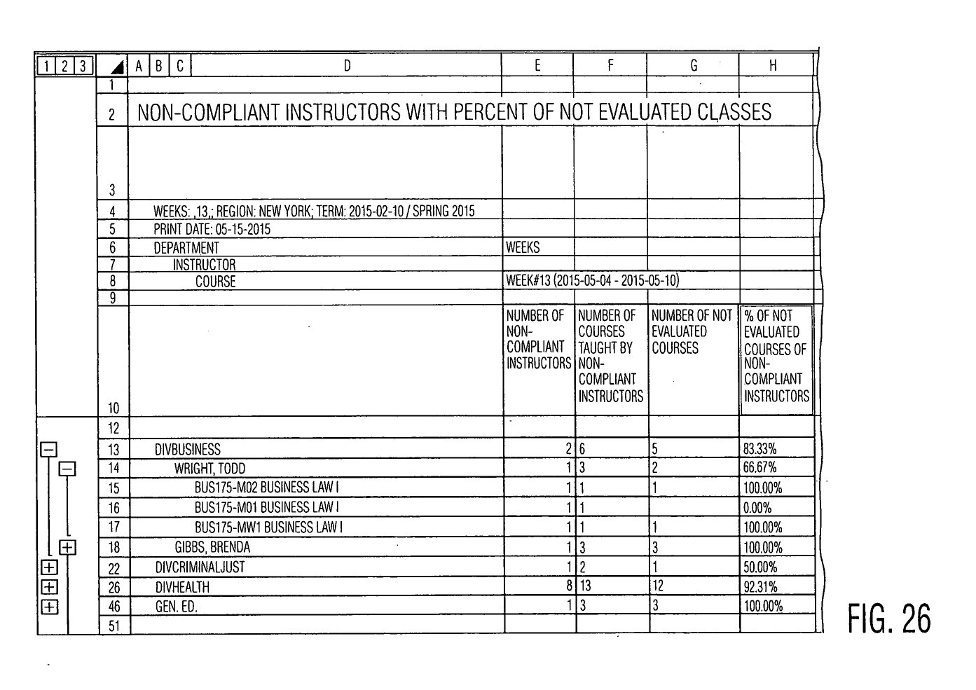

In the report of FIG. 24, students are also assigned as being at risk due to poor attendance. In this case, if a student misses classes for more than 65% from the beginning of the semester and missed an entire reporting week, he or she is identified as being at risk due to the poor attendance. The advisors and school administration contact those students to bring them back to school. When the student returns he or she is subject to counseling with respect to such failure to attend classes and is also assigned tutoring with respect to the missed classes.

The remaining figures not discussed are self-explanatory as to the various computer screens being displayed. It should be understood that the various screens illustrate fictitious names to protect the identities of the actual persons depicted.

It will occur to those of ordinary skill that modifications may be made to the disclosed embodiments. For example, the number and content of the various reports may be changed according to a given implementation. The period of the evaluations and reporting may differ from the weekly period disclosed in the preferred embodiment. The use of instructors, advisors department chair and administration depends upon a particular education institution organization and may include more units or less and thus may differ as may be applicable of the organization. The preferred embodiment disclosed herein is given by way of illustration and not limitation. Such modifications are intended to be included in the scope of the present invention as defined by the appended claims.

What is claimed is:

1. A tutoring management method for an educational institution having an administration, student advisors, instructors, and a Learning Center for providing early identification of the students with academic problems to the institution staff and to the students, the method comprising:
requiring all instructors to assign and record in a data base the academic grades of each of their students on a periodic basis in each of a plurality of a predetermined grade areas correlated to the student's efforts in a classroom at learning the involved course subject, to monitor the performance of each said student on the periodic basis during a given academic term, and to require all students at academic risk having a grade in any of the grade areas below a predetermined level to attend tutoring and/or not meeting attendance requirements;
requiring the instructor to assign a tutor which may include that instructor or other tutors to each such student at risk and monitor the progress of that student being tutored and enter such into the data base;
permitting each such tutored student, instructors, administration, advisors and students instructors to access the progress of each such student at any time as entered in the data base; and
providing periodic reports as to the academic progress of such tutored students to administration, advisors, students and instructors which reports including providing reports to administration of all instructors not in compliance with requiring students to attend at least one tutoring session and not in compliance with requiring the assignment of tutoring of each such student at risk based on data entered in the data base.

2. The method of claim 1 including requiring the instructors to provide periodic predetermined grades to each of their students in class participation, required reading, quizzes, answering questions in class, and assignments/homework.

3. The method of claim 1 including requiring the instructors to provide periodic reports to each of their students in reference to their class participation, required reading, quizzes, answering questions in class, and assignments/homework wherein the periodic assignment of grades is on about a weekly basis.

4. The method of claim 1 including emailing periodic summary reports to the instructors of students at risk.

5. The method of claim 1 automatically emailing reports to students requiring tutoring.

6. The method of claim 1 automatically emailing the periodic reports by email notification to the instructors with respect to students at risk requesting the instructors to schedule tutorials for such students.

7. The method of claim 1 providing student advisors for counseling students and permitting the student advisors to access the data base and to receive automated email notifications as to students at risk including summary and detailed reports of evaluated students at risk.

8. The method of claim 1 including providing the periodic reports as automated email notification summary reports to the administration with respect to students at risk for whom tutoring is required.

9. The method of claim 6 wherein the institution is a school of higher education that has departments specializing in different areas of study, including multiple school campuses, each having student advisors, departments, instructors, subjects and students, the method for providing the notification as a summary report listing for a given campus and department including each subject for each student at risk.

10. The method of claim 1 including the step of permitting the advisors to access the data base and provide a periodic progress report with comments provided by each advisor for students at risk or reporting whether or not all attending students are at risk.

11. The method of claim 1 including providing a computer screen listing a schedule of new tutoring with a view of pending sessions listing student, instructor, advisor, tutorial assignment, and status.

12. The method of claim 1 including providing a computer screen for advisors use displaying a schedule of student's tutoring, for all students whether or not needing tutoring, having a home page, a weekly progress report, and other reports, an arrangement for selecting student, the week involved, comments, dates and campus.

13. The method of claim 1 further including providing a computer screen for subject mapping of available subjects and listing assigned subjects.

14. The method of claim 1 further including providing a computer screen for providing a tutoring schedule for tutors listing department, instructor and days/times assigned.

15. The method of claim 1 further including providing a computer screen for providing a list of reports that are available including summary of students at risk by instructor, by advisor, by program of study, by admission rep, non-compliant instructors, summary tutorials outcome, term summary students at risk by admission rep, term students with grades below B by program, term students with grades below B by department.

16. The method of claim 1 wherein the method includes providing the advisors access to the data base, including providing a computer screen accessible to the advisors for providing a weekly summary of students at risk by advisor, by instructor, and by program of study.

17. The method of claim 1 further including providing a computer screen providing a display of non-compliant instructors with percent of not evaluated classes.

18. The method of claim 1 further including providing a computer screen providing a display of a drill down report that can be opened to the student level providing a summary of tutorials outcome.

19. The method of claim 1 further including providing a computer screen which displays students with grades below B by department.

20. The method of claim 17 wherein the display includes students/courses by program with grades below B, were at risk at least once, total provided tutorials, cumulative attendance, final grade and midterm grade.

21. The method of claim 1 including providing a Learning Center in which students, professional tutors or instructors serve as tutors for walk in students requesting tutoring, students assigned tutoring from part time instructors or others.

22. The method of claim 1 further including assigning a student as being at risk for poor attendance.

23. A tutoring management method for an educational institution having an administration, instructors, advisors and students for providing tutoring and an early identification of the students with academic problems to the institution staff and to the students, the method comprising:
require all instructors to frequently periodically monitor and record in a data base the student academic standings in grade form for a plurality of class work criteria for all courses of instruction given by the corresponding instructor and for each student of that instructor;
mandate each instructor, for each student whose academic standing falls below a given predetermined academic grade level in any of the predetermined grade levels, a grade below the predetermined level manifesting a student at risk, to require that student to attend a tutoring program for each such course and enter that requirement in the data base;
require each such instructor having a student attending the tutoring program, to provide such tutoring or arrange for the tutoring of that student and record that information in the data base;
periodically monitor the progress of students attending the tutoring program via accessing the data base;
monitoring and recording in the data base all instructors not complying with the mandating step, not providing the tutoring or not arranging a tutor for a student;
providing each student, instructor, advisor and the administration access to the data base and provide periodic reports to such persons of the academic progress of each student for each course of instruction taken by such student; and
providing periodic reports to the administration of such non-complying instructors.

24. The method of claim 22 wherein the requirement that all instructors periodically monitor and record in a data base the student academic standings in grade form for a plurality of class work criteria for all courses of instruction be performed about weekly;

25. The method of claim 22 including providing a Learning Center for providing tutoring to the students at risk and others, the Learning Center including tutors comprising students, instructors and professional tutors for receiving and tutoring students assigned thereto and other individuals requesting tutoring or assigned tutoring by a part time instructor or others.

26. The method of claim 23 further including assigning a student as being at risk for poor attendance.

27. A tutoring management method for an educational institution having administration, instructors, advisors and students, for providing tutoring and an early identification of the students with academic problems to the institution staff and to the students, the method comprising:
requiring instructors to periodically on a frequent basis during a term assign each of their students a grade in a plurality of different criteria correlated to student performance in a class room environment with respect to a given course subject, and enter such grade into a data base;
requiring each instructor to assign tutoring to each of their students having a grade below a given threshold level that puts the student at academic risk and enter that information in the data base;
automatically notifying management of non-compliant instructors with respect to assigning grades or tutoring to students at risk and notifying instructors, students, advisors, and automatically notifying management regarding the result of frequent periodic student evaluations in each course of study with respect to the different criteria.

28. The method of claim 25 wherein the frequent basis for assigning students a grade is about weekly, and the frequent periodic notification of management of student evaluations is about daily.

29. The method of claim 25 wherein the different criteria for grading a student on a weekly basis comprises class room participation, homework/assignments, answering questions during class, required reading and quizzes,

30. The method of claim 25 including requiring a student to be assigned tutoring on the basis of class room attendance.
